(19) United States
(12) Patent Application Publication
(10) Pub. No.: US 2016/0102478 A1
(43) Pub. Date: Apr. 14, 2016

(54) LOCK WITH A DOOR HANDLE CONTACT

(71) Applicant: DORMA Deutschland GmbH, Ennepetal (DE)

(72) Inventors: Marc-Andre SCHNEIDER, Ennepetal (DE); Kai GRONE, Ennepetal (DE)

(21) Appl. No.: 14/877,419

(22) Filed: Oct. 7, 2015

(30) Foreign Application Priority Data
Oct. 8, 2014 (DE) 102014220412

(51) Int. Cl. E05B 63/00; E05B 47/00; H02K 7/14; E05F 15/70; E05F 15/40; E05B 65/10; E05F 15/603

(52) U.S. Cl. CPC E05B 63/0069; E05B 65/1046; E05B 47/0012; E05F 15/603; E05F 15/70; E05F 15/40; H02K 7/14; E05B 2047/0048; E05B 2047/0084; E05B 2047/0067

(57) ABSTRACT

A lock with a door handle and/or an anti-panic bar, which is/are operatively connected to a follower that can be coupled and uncoupled, with an electromechanical energizing unit and at least one sensor for the access control of a door, where in an uncoupled condition of the follower, the follower is in a contact position with the sensor, and wherein by activating the electromechanical energizing unit, the follower can be transferred into a coupling condition, wherein, in the coupling condition, the follower releases the sensor into a release position by actuating the door handle and/or the anti-panic bar, where the follower includes an arm with a rotatably supported actuating element, where, in the coupling condition, by actuating the door handle and/or the anti-panic bar, the actuating element releases the sensor from the contact position into the release position.

### CROSS REFERENCE TO RELATED APPLICATION

This application is related to and claims the benefit of German Patent Application Number 102014220412 filed on 8 Oct. 2014, the contents of which are herein incorporated by reference in their entirety.

### TECHNICAL FIELD

The present invention relates to a lock as well as to an access control method for a door including a lock.

### BACKGROUND

Locks defining said species are mostly equipped with a dead-bolt and a latch-bolt, which together with other mechanical and electronical functional elements of the lock are disposed in a lock casing. Usually, the latch-bolt and the dead-bolt can be unlocked together by means of an inside door handle, which is located within the building and inside the follower or the handle follower, for example of an anti-panic lock. On the outside of the door, i. e. outside the building or an area accessible only with an access authorization, without prior access authorization via the outside door handle, the dead-bolt and, if required, neither the latch-bolt cannot be unlocked, because the follower is uncoupled, and the rotary movement of the outside door handle is not transferred onto the follower. In said uncoupled condition of the follower, the follower is in a contact position with a sensor, which is usually a microswitch with a switch tag, In the event the door is enabled for traffic to pass, for example via a chip or a card or via another access control, respectively access authorization system, the follower is transferred into a coupling condition by means of an electromechanical energizing unit, by transferring the rotary movement of the outside door handle onto the follower.

Thereby, when actuating the door handle, the follower is moved along and releases the sensor into a release position. In the release position, the sensor transmits a signal to the access authorization system, which allows to verify whether or not passing the door was legitimate, namely in the coupling condition of the follower, which allows for a rotary movement of the outside door handle onto the follower. So that the inside door handle and/or an anti-panic bar in the escape direction, i. e. in the direction out of the building, is always in the coupled condition, and the outside door handle, in the event of unauthorized access, is in an uncoupling condition, respectively can be coupled after an authorization, for example via an access control system, it is known to configure the follower with an upper follower half and a lower follower half, and with an intermediate follower center member. In this case, the follower-half, which is connected to the inside door handle and/or to the anti-panic bar located inside the building, is always in the coupling position with the follower center member. Usually, a blocking disc, which allows for a manual pre-adjustment of the lock in relation to the outside or the inside door, is placed at least onto the follower-half, which is connected to the outside door handle, which in turn is fastened to the outside of the door. In addition, an electromechanical energizing unit can be activated via a connecting lever, whereby the uncoupling condition can be changed into the coupling condition.

The known locks are disadvantageous in that they are specified with regard to their orientation, i. e. the side of the escape direction and the side of the access authorization, because the positioning of the door handle contact, which is configured as a microswitch, is determined when the microswitch is bonded. Therefore, subsequent retrofitting of the known locks is not possible. In addition, the known locks are disadvantageous in that, when the switch tag of the microswitch, which is configured as a door handle contact, is switched off, the tag needs to be rebent, in order to ensure a defined switching order, which requires bending of the switch tag several times, ultimately resulting in material fatigue of the microswitch and possibly in losing the good functioning of the microswitch. In addition, the known locks do not allow for adjusting the switch tag, respectively for adjusting in the assembled condition and/or when the lock is already in the installed condition.

### BRIEF SUMMARY

The invention seeks to overcome the known disadvantages of the state-of-the-art. Particularly, the invention provides a lock with a door handle contact, which is versatile in its application and in which the adjustment of the switching order is simplified, which advantageously may be likewise realized in the assembled condition of the lock.

The inventive lock with a door handle and/or an anti-panic bar, which is/are operatively connected to a follower that can be coupled and uncoupled, with an electromechanical energizing unit and with at least one sensor for the access control of the door, wherein in an uncoupled condition of the follower, the follower is in a contact position with the sensor and wherein by activating the electromechanical energizing unit, the follower can be transferred into a coupling condition, wherein, in the coupling condition, by actuating the door handle and/or the anti-panic bar, the follower releases the sensor into a release position, includes the technical teaching that the follower comprises an arm with a rotatably supported actuating element, wherein in the coupling condition and by actuating the door handle and/or the anti-panic bar, the actuating element releases the sensor from the contact position into the release position.

Said solution offers the advantage, that by means of the additional actuating element, which is configured at the arm of the follower and is rotatably supported in the arm and which releases the sensor from the contact position into the release position, by means of which the actuating element which is rotatably supported in the arm of the follower, the adjustment of the switching order is simplified, namely by rotating the actuating element in relation to the arm of the follower, i. e. by an adjustment at the actuating element. Moreover, the additional rotary movement of the actuating element, complementary to the rotary movement of the arm of the follower, allows for larger tolerance compensation so that the actuation, i. e. the switching order of the sensor, which is preferably configured as a microswitch, can be adjusted.

Basically, it would be conceivable to actuate the sensor, which in this case is particularly and preferably configured as a microswitch, via the actuating element, i. e. for example to switch the microswitch on and off. In this case, the microswitch may be actuated in the contact position and/or in the release position.

In a preferred manner, the actuating element comprises a pin, which contacts respectively releases the switch tag of the sensor, which is configured as a microswitch. With the intention to even increase the adjustment options between the actuating element and the sensor, in this case in a preferred manner, the pin is configured to be eccentric at the actuating element. As the actuating element is rotatably supported at the arm of the follower, the number of potential positions of the pin, which is disposed at the actuating element, can be considerably increased by means of the eccentric disposition thereof at the actuating element. According to the invention, rotating the actuating element results in a very detailed and fine adjustment of the switching order of the inventive lock. In this case, in the uncoupling condition of the follower, it is intended that the pin contacts the switch tag of the sensor, which is configured as a microswitch, in such a manner that the microswitch is actuated in the basic position, i. e. the switch tag is pressed. With the intention to allow for compensating tolerances created during the manufacturing process of the locks, according to the invention, in the uncoupling position of the follower, it is known to be able to adapt the arm, which is positioned in the area of the sensor configured as a microswitch, via the rotatably supported actuating element configured at the arm, to the position of the sensor configured as a microswitch, such that despite existing tolerances, the basic position of the microswitch, namely the actuation of the switch tag, can always be adjusted, respectively is always guaranteed. Said configuration of the actuating element at the arm of the follower makes rebending of the switch tag redundant. In case, in the uncoupling condition of the follower, the pin configured at the actuating element is too far away from the switch tag of the microswitch such that the door handle contact will not be actuated, simple rotating of the actuating element and thereby rotating of the pin, which is eccentrically disposed at the actuating element, allows for moving the pin as far as to the switch tag of the microswitch, that the basic position can be adjusted, namely the switch point of the microswitch in the basic position.

In advantageous manner, the adjustment of the actuating element is realized at the actuating element at the side opposite the pin. Advantageously for this purpose, the actuating element may present a reception for a tool, for example a slot, a crossed slot or an equivalent recess, which allows for the reception of a tool, and allows for actuating, for example via a screwdriver. In a particularly preferred manner, in the inventive lock, unlike the locks known from the state of art, an adjustment of the actuating element can be realized in the closed condition of the lock, i. e. with an assembled lock.

In a preferred manner, the follower of the inventive lock comprises two follower-halves and a center member, wherein in a preferred manner, the arm, at which the actuating element is disposed, is configured at the center member of the follower, respectively is in operative connection with the center member of the follower. In this case, the orientation of the lock in relation to the escape and to the securing side can be specified in a preferred manner via the two follower-halves, and via blocking discs, which can be placed onto the follower-halves. If, the uncoupled follower-half is transferred into a coupling condition, for example via the electromechanical energizing unit, which is likewise understood as an electromagnetic energizing unit or as an electric motor, upon actuating the door handle and/or the anti-panic bar in the coupling condition, the follower center member and the arm, which is configured at the center member, are moved together with the actuating element, which is disposed thereat. Upon actuating the door handle and/or the anti-panic bar, in this case a rotary movement of the follower and thereby likewise a rotary movement of the arm, which is configured at the center member of the follower, are preferably realized. During the rotary movement of the center member, the arm, which is connected to the center member, is moved away from the sensor, i. e. in this case preferably away from the microswitch. In this case, obviously likewise the actuating element, which is disposed at the arm, and the pin, which is connected to the actuating element and which, in the basic position, actuates the switch tag of the sensor, which is configured as a microswitch, is moved away from the switch tag. Thereby, the pin releases the sensor, i. e. in this case in particular the switch tag of the sensor, which is configured as a microswitch. Releasing the sensor by means of the actuating element, i. e. here in an advantageous manner by means of bringing the pin out of contact from the switch tag of the microswitch, it is possible to verify via the release position of the sensor, whether or not the door was legitimately accessed, i. e. in the coupled condition of the follower, after an access authorization by actuating the door handle was realized. In this case, the signal of the sensor can be forwarded to the access control system or to other surveillance systems. Obviously, the follower may be configured to be in one part, wherein then a knob is preferably disposed on the access side of the door, which does not allow for passing the door, and an inside door handle or an anti-panic bar is disposed on the anti-panic side of the door, in order to be able to operate the door in an emergency event, i. e. to be able to open the door.

In the inventive access control method for a door with a lock, in particular with the inventive lock, which comprises a door handle and/or an anti-panic bar, a follower, an electromechanical energizing unit, and a sensor, in a closed condition of the door, it is intended that the follower is in a contact position with the sensor, wherein, for opening the door following an access authorization request via an access control system, the follower is transferred into a coupling condition by means of the electromechanical energizing unit and, by actuating the door handle and/or the anti-panic bar, the follower releases the sensor into a release position, in which the sensor transmits a signal in particular to the access control system to allow for the passing the door.

With the intention to avoid repeating the advantages of the inventive method, it is referred to the description of the advantageous embodiment of the inventive lock and it is fully and comprehensively referred to the latter.

Hereinafter, further measures enhancing the invention are illustrated in the following in detail in conjunction with the description of one preferred embodiment of the invention reference being made to the Figures. In this context, the features mentioned in the claims and in the description, individually or randomly combined, may be essential to the invention. In this case, it should be noted that the figures have illustrative purpose only and are not all intended to limit the invention in any possible way.

### BRIEF DESCRIPTION OF THE DRAWINGS

FIG. 1 shows a section of an inventive lock in a basic position, in which a sensor, configured as a microswitch, is in a contact position with the actuating element,

FIG. 2: shows the lock of FIG. 1 in the release position of the sensor of the actuating element, and

FIG. 3: shows a section of the rear side of the detailed view of the lock illustrated in FIGS. 1 and 2.

### DETAILED DESCRIPTION

Throughout the different Figures, the same parts are always identified by the same reference numeral, and therefore they will be normally only described once.

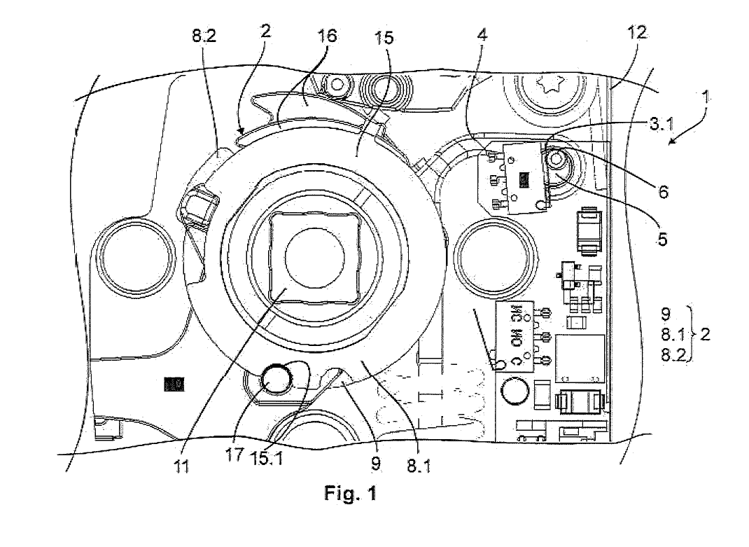

FIG. 1 shows a section of an inventive lock 1, wherein preferably the functional elements of the lock 1 relevant for the invention are identified. However, the limitation to the functional elements, respectively features of the lock relevant to the invention is not intended to be delimiting to the functioning of the lock 1. All functional elements of the lock 1 are disposed in a lock casing 12, which can be inserted into a door.

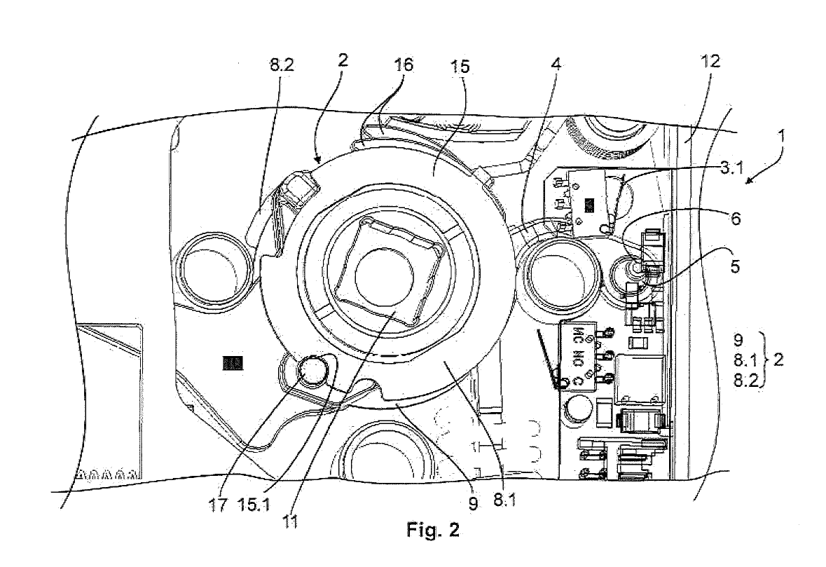

The lock 1 includes a follower 2, which can be coupled and uncoupled, and is operatively connected to a door handle which is not illustrated here via a handle reception 11. In the present case, the follower 2 comprises a front follower-half 8.1 and a rear follower-half 8.2, and a follower center member 9. Following a positive authorization or a granted access request directed to an access control or authorization system, for example via a chip or a card, the follower 2 can be coupled via an electromechanical energizing unit (not illustrated here). In the coupling condition of the follower 2, an arresting means 17 engages in the recess 15.1 of the blocking disc 15. Moreover, the inventive lock includes a sensor 3, which in the present case is configured as a microswitch with a switch tag 3.1. In the present case, the switch tag 3.1 of the sensor 3, which is configured as a microswitch, is in a contact position. In a release position, which is illustrated in the following FIG. 2, the switch tag 3.1 of the sensor 3 configured as a microswitch is in a release position. In the release position, the microswitch configured as a sensor 3 transmits a signal for example to the access control system, whereby a legitimate passing of the door in the coupling condition of the follower 2 can be verified. In order to maintain the microswitch configured as a sensor 3, namely in this case the switch tag 3.1 of the sensor 3, in a contact position, respectively to release it from the contact position into a release position, at an arm 4, which is configured at the follower 2, an actuating element 5 is disposed and rotatably supported at the free end of the arm 4. In the present case, the actuating element 5 comprises a pin 6, which is configured at the actuating element 5, which pin is eccentrically disposed at the actuating element 5. In the present case, the pin 6 is aligned with the actuating element 5 in such a manner that the pin 6 maintains the switch tag 3.1 of the sensor 3 configured as a microswitch in a contact position, i. e. in a pressure position. The arm 4, at which the actuating element 5 is disposed, as illustrated is configured at the follower center member 9 of the follower 2. For indicating the orientation of the situation of the arm 4, in the present case the actuating arm 10 is identified, which is preferably integrally configured with the follower center member 9 and extends away from the handle reception 11. Usually, the actuating arm 10 serves for activating a lock mechanism. It is thus for example possible to retract a dead-bolt into the lock casing 12 of the lock 1 or else a latch-bolt 13 or a claw latch-bolt 14 can be moved by activating the closing mechanism. In addition and serving the orientation, connecting levers 16 are configured at the follower center member 9 of the follower 2. The connecting levers 16 are articulately disposed at the follower center member 9 and are able to move between an engaging position and a release position. In case the connecting levers 16 are brought into a release position, in the present case as illustrated in FIG. 1, a rotary transfer onto the handle reception 11, i. e. onto the follower center member 9 is interrupted. In this condition the follower 2 is in an uncoupling condition, in which a rotary movement of the door handle is not transferred onto the follower 2 via the handle reception 11. Therefore, in the uncoupling condition of the follower 2, the arm 4 configured at the follower center member 9 and the actuating element 5 disposed at the actuating element 5 are not movable either.

Blocking discs are associated to the connecting levers 16, wherein in this case just the front blocking disc 15 can be recognized, which is rotatably placed onto the front follower-half 8.1 of the follower 2. The blocking disc 15 is thereby adjustable so that the connecting levers 16 are brought into the engagement position, respectively the associated connecting levers 16 are transferred into the release position. By bringing the arresting means 17 into engagement with the recess 15.1 of the blocking disc 15 and by the blocking disc 15 acting upon the connecting levers 16, the coupling condition of the follower 2 can be produced, i. e. in an advantageous manner the rotary movement of the outside door handle can be transferred onto the follower center member 9 via the handle reception 11.

By guiding along the follower center member 9 during a rotary movement of the door handle in the coupling condition of the follower 2, the arm 4, which is configured at the follower center member, and the actuating element 5, which is rotatably disposed at the arm 4, are also moved along. By means of the follower center member 9 of the follower 2 moving along due to the rotary movement of the door handle, the actuating element 5 releases the sensor 3, which is configured as a microswitch, into a release position, in which the pin 6 disposed at the actuating element 5 is moved out of the contact position with the switch tag 3.1 of the sensor 3, which is configured as a microswitch, into a release position of the switch tag 3.1.

FIG. 2 shows the sensor 2 configured as a microswitch in the release position released by the actuating element 5. As can be seen, by leading down the arm 4 with the follower 2 being coupled, namely by guiding along the follower center member 9 by means of the rotary movement, which is transferred onto the follower 2 by the door handle, the arm 4 and the actuating element 5 configured at the arm 4 have been guided along in the direction of the rotary movement, clock-wise in the Figure, such that the pin 6, which is configured at the actuating element 5, is located outside the contact position, illustrated in FIG. 1, from the switch tag 3.1.

The actuating arm 10, which is integrally configured with the follower center member 9, has been moved along by means of the rotary movement, which is transferred via the door handle and via the handle reception 11 onto the follower 2. Correspondingly, the lock mechanism of the door lock 2 is activated during a transfer of the rotary movement from the door handle onto the follower 2 via the actuating arm 10, and simultaneously therewith, in the release position, the sensor 2 configured as a microswitch transmits a signal, for example to the access control authorization system, whereby, with the follower 2 being coupled, the legitimate access of the door and/or the functioning the lock mechanism can be verified.

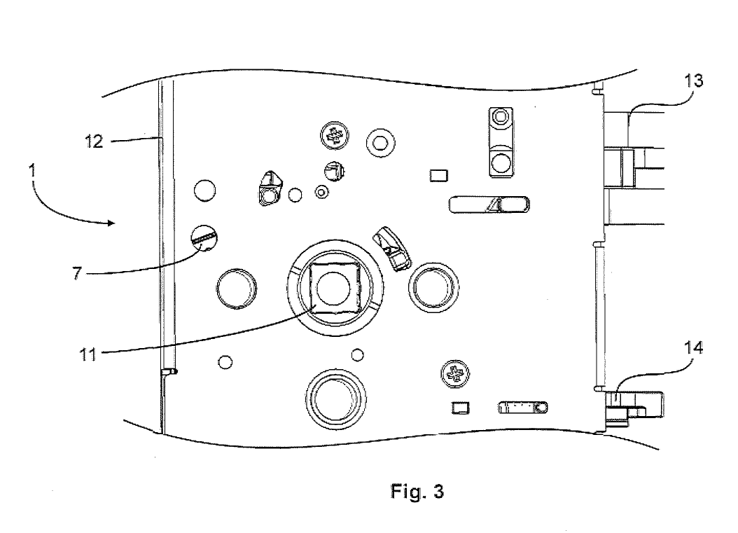

FIG. 3 shows a cutout of the rear side of the lock casing 12, which accommodates the inventive lock 1. The latch-bolts 13 and 14 can be seen on the right hand side of the lock casing 12. It can be optionally chosen to dispose the front side of the lock shown in FIGS. 1 and 2 and the back side of the lock illustrated in FIG. 3 either towards the building inside, i. e. the secured area of a building as well as to the building outside, namely to the side of the access control system. Depending on the arrangement of the lock 1, it is via the blocking disc 15, which is placed upon the front half 8.1 of the follower 2, that the permanent coupling condition can be set for the inside door handle, namely on the emergency escape side. As can be seen, the actuating element 5 is adjustable via the adjusting element 7. In the present case, the adjusting element 7 is configured as a slot configured in the actuating element 5 and intended for the reception of a screwdriver. Obviously, the adjusting element may be configured differently as well, namely for example in the shape of a cross-recess, an internal hexagon or a star-shaped accommodation, in order to allow for operating a correspondingly configured tool, in particular to turn the adjusting element 7 with the actuating element 5. By turning the actuating element 5 via the adjusting element 7, the pin 6, which is eccentrically disposed at the actuating element 5, is moved along the circular path of the actuating element 5, whereby the signal order is easily adjustable by means of the tool, respectively can be switched over subsequently. Moreover, the adjustability of the actuating element 5 allows for a simple post-adjustability of the pin 6, namely the contact position thereof at the switch tag 3.1, respectively allows for a very simple post-adjustability even in the closed condition of the lock, i. e. when the lock is assembled. As in the present case, the actuating element 5 is operatively connected just to the follower center member 9, it is just the coupled condition of the follower 2, namely the transfer of the rotary movement of the door handle onto the follower 2 via the handle reception 11 that can be queried.

The invention in its configuration is not limited to the above-indicated preferred embodiment, respectively to the above-indicated method. On the contrary, a number of variants are conceivable, which make use of the illustrated solution, even with basically different types of embodiments.

All features and/or advantages including the constructional details, spatial dispositions and method steps, resulting from the claims, the description or the drawings, may be essential to the invention, both by themselves and in the most various combinations.

1. A lock with a door handle and/or an anti-panic bar, which is/are operatively connected to a follower that can be coupled and uncoupled, with an electromechanical energizing unit and at least one sensor for access control of the door, wherein in an uncoupled condition of the follower, the follower is in a contact position with the sensor and wherein by activating the electromechanical energizing unit, the follower can be transferred into a coupling condition, wherein, in the coupling condition by actuating the door handle and/or the anti-panic bar, the follower releases the sensor into a release position, wherein the follower comprises an arm with a rotatably supported actuating element, wherein in the coupling condition, by actuating the door handle and/or the anti-panic bar, the actuating element releases the sensor from the contact position into the release position.

2. The lock according claim 1, wherein the actuating element comprises a pin, which is eccentrically disposed at the actuating element.

3. The lock according claim 2, wherein the actuating element contacts and/or releases the sensor via the pin.

4. The lock according claim 2, wherein the pin is adjustable.

5. The lock according claim 4, wherein the signal order and/or the switch point of the sensor is/are adjustable via the adjustment of the pin.

6. The lock according to claim 2, wherein the adjustment of the pin at an adjusting element is realized on the side of the actuating element opposite the pin.

7. The lock according to claim 1, wherein the follower comprises two halves and a center member.

8. The lock according claim 7, wherein the arm with the actuating element is disposed at the center member.

9. The lock according claim 7, wherein in the coupling condition of the follower, upon actuation of the door handle and/or of the anti-panic bar, the follower center member can be moved along.

10. An access control method for a door with a lock, comprising a door handle and/or an anti-panic bar, a follower, an electromechanical energizing unit and a sensor, wherein in a closed condition of the door, the follower is in a contact position with the sensor, wherein, for opening the door following an access authorization request via an access control system, the follower is transferred into a coupling condition by means of the electromechanical energizing unit and by actuating the door handle and/or the anti-panic bar, the follower releases the sensor into a release position, in which the sensor transmits a signal to allow for passing the door, in particular to the access control system.
